(19) United States
(12) Patent Application Publication
(10) Pub. No.: US 2007/0124543 A1
(43) Pub. Date: May 31, 2007

(54) Apparatus, system, and method for externally invalidating an uncertain cache line

(76) Inventors: Sudhir Dhawan, (US); James Otto Nicholson, Pflugerville, TX (US)

Correspondence Address: KUNZLER & ASSOCIATES, 8 EAST BROADWAY, SUITE 600, SALT LAKE CITY, UT, 84111, US

(21) Appl. No.: 11/287,949

(22) Filed: Nov. 28, 2005

(51) Int. Cl. G06F 13/28

(52) U.S. Cl. 711/144

(57) ABSTRACT

An apparatus, system, and method are disclosed for externally invalidating an uncertain cache line. In one embodiment, a monitor module monitors a processor module bus. A detection module detects a processor module evicting a cache line from a cache module. The cache line may be in an uncertain state. An invalidation module invalidates the cache line with an invalidation command directed to the processor module. In one embodiment, an update module updates a cache directory external to the processor module. The apparatus, system, and method increase memory and processor bandwidth by eliminating the need to snoop the processor module bus for evicted cache lines.

### BACKGROUND OF THE INVENTION

1. Field of the Invention

This invention relates to invalidating a cache line and more particularly relates to externally invalidating a cache line evicted by a processor module that may still be valid for the processor module.

2. Description of the Related Art

Data processing devices (“DPD”) such as servers, mainframe computers, computer workstations, and the like typically include a microprocessor or central processing unit (“CPU”) referred to herein as a processor module. The processor module executes instructions that may comprise one or more software processes. In addition, the processor module processes data as directed by the instructions.

A DPD typically stores instructions and data, herein referred to for simplicity as data, in a memory module. The memory module may employ a plurality of memory devices such as dynamic random access memory (DRAM”), static random access memory (“SRAM”), flash random access memory (Flash RAM”), and the like to store the data. The memory module organizes the memory devices as a plurality of addressable memory locations for storing the data. For example, the memory module may store a first data value in the memory location addressed by the hexadecimal address ‘100x’.

The memory module typically communicates the data to the processor module over one or more electronic data buses. In one embodiment, the memory module communicates over a first data bus to a north bridge module. The north bridge module further communicates with the processor module over a processor module bus. The north bridge module may manage communications between the processor module and the memory module.

Communications between the processor module and the memory module are typically significantly slower than communications within the processor module. As a result, processor modules often include internal memory referred to as a cache module. The cache module is designed to store data that is likely to be frequently used by the processor module such as recently used data.

The cache module data is organized as a plurality of cache lines. Each cache line typically stores data from a plurality of memory locations. Data stored in the cache line is addressed using the data's memory location address in the memory module. The cache module intercepts data reads and writes destined for the memory module and directs the data be read from or written to the cache module. For example, the cache module may store the first data value in a cache line that corresponds to the address ‘100x’. A write to address ‘100x’ will be written to the cache line while a read from ‘100x’ will also be read from the cache line.

The cache module may be internal to the processor module. A cache module internal to the processor module may be limited to a smaller number of memory locations. As a result, the DPD often includes an external cache module in communication with the processor module through the processor module bus. The processor module bus may be referred to as a front side bus (“FSB”). The external cache module typically includes a larger number of memory locations.

In a DPD with one or more cache modules, the most current instance of a specified data value may reside in one or more locations such as one or more internal caches, an external cache, and a memory module. As a result, the DPD may include a cache directory to track the location of a data value. For example, the cache directory may record that a first cache module internal to the processor module stores the most current instance of the first data value.

An internal or external cache module may be configured as a write-through cache. A write-through cache writes data to the memory module immediately subsequent to the data being written to the cache module. A cache module may also be configured as a write-back cache. A write-back cache stores data written to the cache module, but does not immediately write the data to the memory module. The data value stored in the cache module and the data value stored in the memory module at a corresponding address may differ for a significant time until the cache module synchronizes the data value to the memory module.

A cache module synchronizes the data value with the memory module by writing the cache line containing the data value to the memory module. A processor module may evict a cache line by writing the cache line to the memory module or an external cache module. Unfortunately, some processor modules may evict a cache line from an internal cache module and leave the status of the cache line in an uncertain state. For example, the processor module may evict the cache line but maintain a current instance of the cache line in an internal cache module. The cache directory must record the cache line in the internal cache module as the current instance, although the memory module also stores current instances of the cache line data.

When the internal cache line is in this uncertain state, the DPD cannot perform any transactions such as a direct memory access (“DMA”) operation involving a data value stored in the memory module that is also stored in the cache line until verifying that an instance of the data value in the memory module is the same as the instance in the cache line. A DPD module such as the north bridge module must query or snoop the cache line that contained the data value in the internal cache module over the processor module bus before executing transactions with the data value stored in the memory module. Unfortunately, snooping the internal cache module using the processor module bus delays other processor module functions, degrading DPD performance.

From the foregoing discussion, it should be apparent that a need exists for an apparatus, system, and method that externally invalidate a cache line in an uncertain state. Beneficially, such an apparatus, system, and method would improve DPD performance by reducing snooping of an internal cache module over a processor module bus.

### SUMMARY OF THE INVENTION

The present invention has been developed in response to the present state of the art, and in particular, in response to the problems and needs in the art that have not yet been fully solved by currently available cache line invalidation methods. Accordingly, the present invention has been developed to provide an apparatus, system, and method for invalidating uncertain cache lines that overcome many or all of the above-discussed shortcomings in the art.

The apparatus to invalidate an uncertain cache line is provided with a logic unit containing a plurality of modules configured to functionally execute the necessary steps of detecting a processor module evicting a cache line and invalidating the cache line. These modules in the described embodiments include a detection module and an invalidation module. In one embodiment, the apparatus further includes a monitor module and an update module.

In one embodiment, the monitor module monitors a processor module bus. The processor module bus may be a FSB or the like. The detection module detects a processor module evicting a cache line from a cache module. The cache line may be in an uncertain state subsequent to the processor module evicting the cache line. The processor module may evict the cache line by writing the cache line to an external cache module. The detection module is external to the processor module.

The invalidation module invalidates the cache line with an invalidation command directed to the processor module. In one embodiment, the invalidation command is a write command. In an alternate embodiment, the invalidation command is a bus invalidate command. The invalidation command invalidates the cache line in the cache module, eliminating the need to snoop the cache before performing a transaction such as a DMA operation using the data values in the memory module that had corresponded to the cache line.

In one embodiment, the update module updates a cache directory. The cache directory records the locations of current instances of data values within one or more cache modules and the memory module. The update module may update the cache directory to record that the invalidated cache line of the cache module is invalid. The apparatus invalidates the uncertain cache line, eliminating the need to snoop the cache line in the cache module before accessing the data values of the cache line in the memory module, improving memory bandwidth, reducing DMA latency, freeing up processor module bus bandwidth, and increasing processor module performance.

A system of the present invention is also presented to invalidate an uncertain cache line. The system may be embodied in a DPD such as a computer or a symmetric multiprocessor (“SMP”) server. In particular, the system, in one embodiment, includes a processor module, a memory module, a cache module, a detection module, and an invalidation module.

The processor module executes instructions and processes data. The memory module stores the instructions and data in a plurality of addressable memory locations. The cache module stores the contents of one or more memory locations in one or more cache lines. The processor module may include the cache module as an internal cache.

The processor module may evict a cache line such as by writing the cache line to an external cache module or the memory module. The status of the cache line may be uncertain to one or more modules external to the processor module. The detection module is external to the processor module. In one embodiment, a north bridge module comprises the detection module. The detection module detects the processor module evicting a cache line from a cache module. The invalidation module is also external to the processor module and invalidates the cache line with an invalidation command directed to the processor module. The north bridge module may also comprise the invalidation module.

The processor module receives the invalidation command and invalidates the cache line, assuring that the cache line is invalid. As a result, any operations such as DMA operations involving the data values previously stored in the cache line need not snoop the cache module using the processor module bus prior to using the data values. In addition, if the cache line needs to be evicted from an external cache module, there is no need to issue an invalidation command on the processor module bus. Thus the system increases DPD bandwidth and performance by invalidating the uncertain cache line.

A method of the present invention is also presented for invalidating an uncertain cache line. The method in the disclosed embodiments substantially includes the steps necessary to carry out the functions presented above with respect to the operation of the described apparatus and system. In one embodiment, the method includes detecting a processor module evicting a cache line and invalidating the cache line. The method also may include monitoring a processor module bus and updating a cache directory.

In one embodiment, a monitor module monitors a processor module bus. A detection module detects a processor module evicting a cache line from a cache module. The cache line may be in an uncertain state. An invalidation module invalidates the cache line with an invalidation command directed to the processor module. In one embodiment, an update module updates a cache directory external to the processor module.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

The present invention detects a processor module evicting a cache line from a cache module wherein the state of the cache line may be uncertain. The present invention further invalidates the cache line by directing an invalidation command to the processor module. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a DPD system in accordance with the present invention;

FIG. 2 is a schematic block diagram illustrating one embodiment of a cache manager apparatus of the present invention;

FIG. 3 is a schematic block diagram illustrating one embodiment of a DPD with level 1 cache internal to the processor module in accordance with present invention;

FIG. 4 is a schematic block diagram illustrating one embodiment of a DPD with level 1, level 2, and level 3 cache internal to the processor module in accordance with present invention;

FIG. 5 is a schematic block diagram illustrating one embodiment of an SMP server system of the present invention;

FIG. 6 is a schematic flow chart diagram illustrating one embodiment of an uncertain cache line invalidation method of the present invention;

FIG. 7 is a schematic block diagram illustrating one embodiment of cache line eviction of the present invention; and

FIG. 8 is a schematic block diagram illustrating one embodiment of uncertain cache line invalidation of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

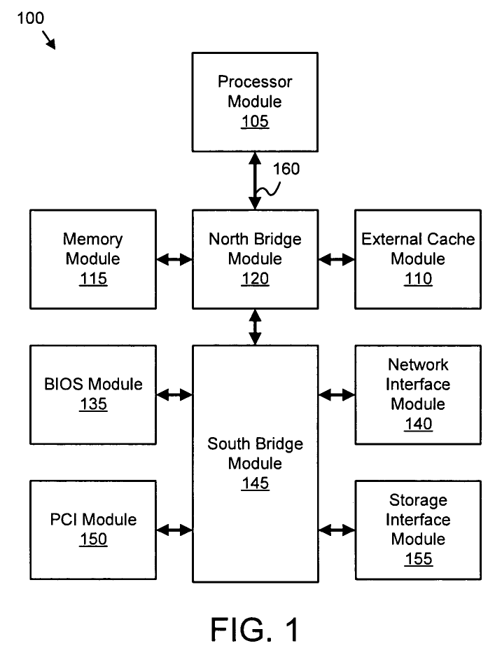

FIG. 1 is a schematic block diagram illustrating one embodiment of a DPD system 100 in accordance with the present invention. The system 100 includes a processor module 105, an external cache module 110, a memory module 115, a north bridge module 120, a basic input/output system (“BIOS”) module 135, a network interface module 140, a south bridge module 145, a peripheral component interface (“PCI”) module 150, and a storage interface module 155.

The processor module 105, external cache module 110, memory module 115, north bridge module 120, BIOS module 135, network interface module 140, south bridge module 145, PCI module 150, and storage interface module 155 may be fabricated of semiconductor gates on one or more semiconductor substrates. Each semiconductor substrate may be packaged in one or more semiconductor devices mounted on circuit cards. Connections between the processor module 105, external cache module 110, memory module 115, north bridge module 120, BIOS module 135, network interface module 140, south bridge module 145, PCI module 150, and storage interface module 155 may be through semiconductor metal layers, substrate to substrate wiring, or circuit card traces, connectors, or wires connecting the semiconductor devices.

The processor module 105 executes instructions and processes data, the instructions and data referred to herein as data. In one embodiment, the processor module 105 employs an x86-based instruction set. For example, the processor module may be a Xeon™ microprocessor manufactured by Intel Corporation of Santa Clara, Calif.

The memory module 115 stores the data in a plurality of addressable memory locations. The processor module 105 communicates with the memory module 115 through the north bridge module 120. The north bridge module 120 communicates with the processor module 105 over a processor module bus 160. The processor module bus 160 may be a FSB. The external cache module 110 also communicates with the processor module 105 through the north bridge module 120. In addition, the external cache module 110 stores the contents of one or more memory locations in one or more cache lines. The processor module 105 may include a plurality of internal cache modules (not shown).

In one embodiment, the north bridge module 120 includes a cache directory. The cache directory may record the locations of current instances of data within the plurality of internal cache modules, the external cache module 110, and the memory module 115. For example, the cache directory may record that a current instance of a specified data value is stored in a cache line of an internal cache module, the specified data value also having the hexadecimal address ‘00FF107x’ in the memory module 115. Because the cache line containing the specified data value is the current instance of the data value, the data value stored in the memory module 115 at ‘00FF107x’ may not be used in an operation such as a DMA operation without first snooping the internal cache module through the processor module bus 160.

The processor module 105 may evict a cache line from the internal cache module. For example, the processor module 105 may write the cache line to the external cache 110. Unfortunately, the status of the cache line maybe uncertain to the cache directory to the processor module 105. For example, the cache directory may record that the internal cache module contains a current instance of the cache line, although the processor module 105 has evicted the cache line. Thus if the north bridge module 120 were to perform an transaction involving data values comprised by the cache line, the north bridge module 120 must first snoop the internal cache module through processor module bus 160. Snooping the internal cache module decreases the processor module bus bandwidth, decreasing the performance of the DPD 100. The present invention detects processor module 105 evicting the cache line and invalidates the cache line to prevent snooping an internal cache module and increase memory and DMA bandwidth when the status of the cache line is uncertain.

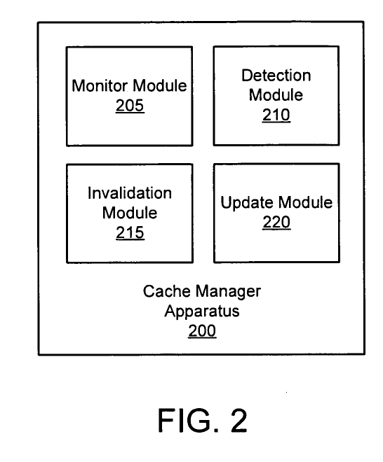

FIG. 2 is a schematic block diagram illustrating one embodiment of a cache manager apparatus 200 of the present invention. The apparatus 200 may be embodied in the system 100 of FIG. 1. In the depicted embodiment, the apparatus 200 includes a monitor module 205, a detection module 210, an invalidation module 215, and an update module 220. In one embodiment, the north bridge module 120 of FIG. 1 comprises the monitor module 205, the detection module 210, the invalidation module 215, and the update module 220.

In one embodiment, the monitor module 205 monitors a processor module bus 160. For example, the monitor module 205 may monitor all transactions over the processor module bus 160. In an alternate embodiment, the monitor module 205 may monitor reads from and writes to the memory module 115 of FIG. 1. In a certain embodiment, the north bridge module 120 of FIG. 1 comprises the monitor module 205.

The detection module 210 detects a processor module 105 such as the processor module 105 of FIG. 1 evicting a cache line from a cache module. The detection module 210 is external to the processor module 105. In one embodiment, the north bridge module 120 comprises the detection module 210. The cache module may also be internal to the processor module 105. The evicted cache line may be in an uncertain state subsequent to the processor module 105 evicting the cache line.

The invalidation module 215 invalidates the cache line with an invalidation command directed to the processor module 105. The north bridge module 120 may comprise the invalidation module 215. In one embodiment, the invalidation command is a write command. In an alternate embodiment, the invalidation command is a bus invalidate command. The invalidation command invalidates the cache line in the cache module, eliminating the need to snoop the cache module before performing a transaction such as a DMA operation using the data values of the cache line.

In one embodiment, the update module 220 updates a cache directory. The north bridge module 120 may comprise the update module 220. In a certain embodiment, the update module 220 updates the cache directory to record that the invalidated cache line of the cache module is invalid. The apparatus 200 invalidates the uncertain cache line, eliminating the need to snoop the cache line in the cache module and freeing up processor module bus 160 bandwidth and increasing memory and DMA bandwidth.

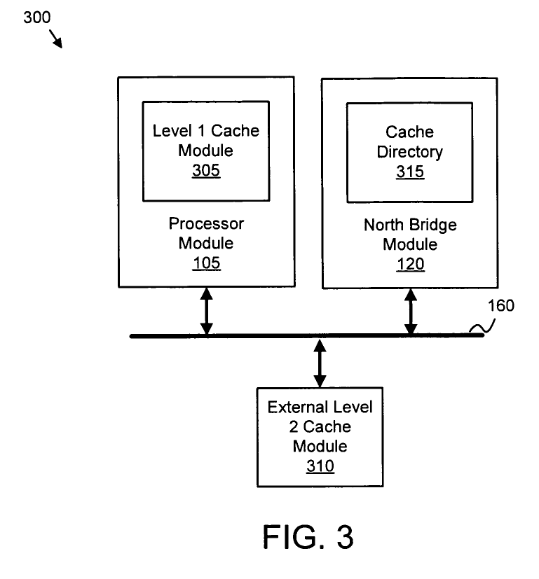

FIG. 3 is a schematic block diagram illustrating one embodiment of a DPD 300 with level 1 cache internal to the processor module 105 in accordance with present invention. For simplicity, the DPD 300 depicts only the processor module 105 and north bridge module 120 of FIG. 1, and an external level 2 cache module 310.

In the depicted embodiment, the processor module 105 includes a level 1 cache module 305. The level 1 cache module 305 may be configured as a write-through cache. The external level 2 cache module 310 may further be configured as a write-back cache. The north bridge module comprises a cache directory 315. The cache directory 315 records the locations of current instances of cache lines in the level 1 cache module 305 and the external level 2 cache module 310.

In one embodiment, the north bride module 120 comprises the detection module 210 and the invalidation module 215 of FIG. 2. The detection module 210 detects the processor module 105 evicting a cache line from the level 1 cache module 305. The invalidation module 215 invalidates the cache line with an invalidation command directed to the processor module 105 and the level 1 cache module 305. The processor module 105 receives the invalidation command and invalidates the cache line. As a result, any operations such as DMA operations involving the data values previously stored in the cache line need not snoop the level 1 cache module 305 using the processor module bus 160 prior to accessing the data values.

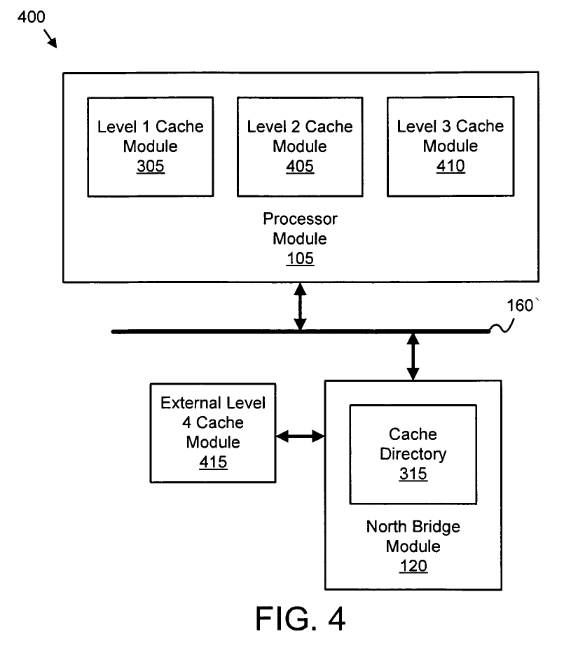

FIG. 4 is a schematic block diagram illustrating one embodiment of a DPD 400 with level 1, level 2, and level 3 cache internal to the processor module in accordance with present invention. For simplicity, the DPD 400 depicts only the processor module 105 and north bridge module 120 of FIGS. 1 and 3, and an external level 4 cache module 415 that may be the external cache module 110 of FIG. 1.

In the depicted embodiment, the processor module 105 includes a level 1 cache module 305, a level 2 cache module 405, and a level 3 cache module 410. The north bridge module 120 comprises a cache directory 315 that records the locations of current instances of cache lines in the level 1 cache module 305, the level 2 cache module 405, the level 3 cache module 410, and the external level 4 cache module 310.

In one embodiment, the north bride module 120 comprises the detection module 210 and the invalidation module 215 of FIG. 2. The detection module 210 detects the processor module 105 evicting a cache line from an internal cache module such as the level 1 cache module 305, the level 2 cache module 405, or the level 3 cache module 410. The invalidation module 215 invalidates the cache line with an invalidation command directed to the processor module 105. The invalidation command may invalidate the cache line in the level 1 cache module 305, the level 2 cache module 405, and/or the level 3 cache module 410.

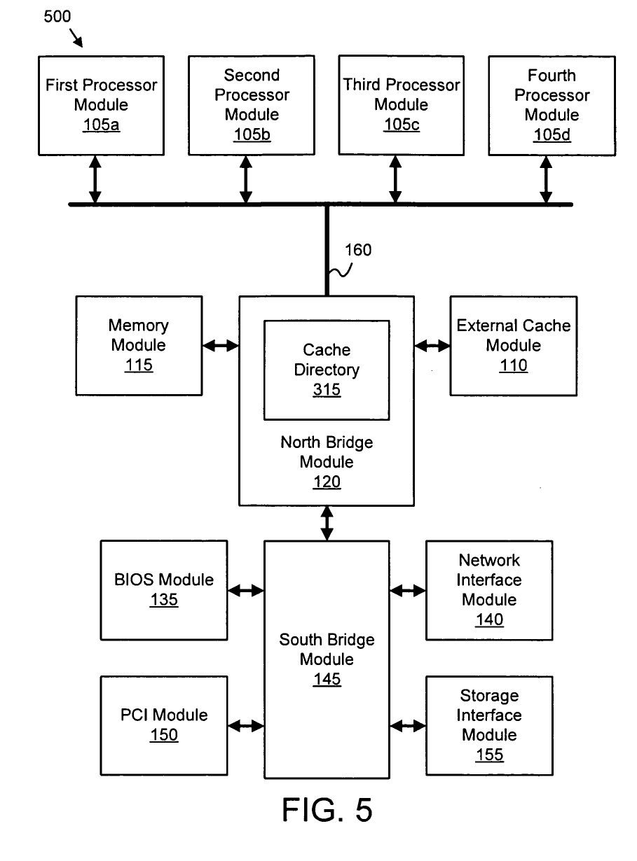

FIG. 5 is a schematic block diagram illustrating one embodiment of an SMP server system 500 of the present invention. The system 500 comprises the apparatus 200 of FIG. 2. As depicted the system 500 includes one or more processor modules 105, an external cache module 110, a memory module 115, a north bridge module 120, a BIOS module 135, a network interface module 140, a south bridge module 145, a PCI module 150, and a storage interface module 155. Although for simplicity the system 500 is depicted with four processor modules 105, any number of processor modules 105 may be employed.

The external cache module 110, the memory modules 115, the north bridge module 120, the BIOS module 135, the network interface module 140, the south bridge module 145, the PCI module 150, and the storage interface module 155 maybe the external cache module 110, the memory modules 115, the north bridge module 120, the BIOS module 135, the network interface module 140, the south bridge module 145, the PCI module 150, and the storage interface module 155 of FIG. 1. Each processor module 105 may access the memory module 115, the BIOS module 135, the network interface module 140, the south bridge module 145, the PCI module 150, and the storage interface module 155 through the north bridge module as in FIG. 1. In one embodiment, each processor module 105 includes the level 1 cache module 305, level 2 cache module 405, and level 3 cache module 410 of FIG. 4 and the external cache module 110 is the external level 4 cache module 415 of FIG. 4. In an alternate embodiment, each processor module 105 includes the level 1 cache module 305 of FIG. 3 and the external cache module is the external level 2 cache module of FIG. 3.

In one embodiment, the north bride module 120 comprises the detection module 210 and the invalidation module 215 of FIG. 2. The detection module 210 detects a processor module 105 such as the first processor module 105a evicting a cache line from an internal cache module. The invalidation module 215 invalidates the cache line with an invalidation command directed to the first processor module 105a, assuring that the cache line is invalid in the processor module's 105 internal cache module. The north bridge module 120 may perform DMA operations to the data values of the cache line that reside in the memory module 115 without snooping on the processor module bus 160, increasing DMA bandwidth. In addition, if a cache line needs to be evicted from the external cache module 110, the north bridge module 120 need not issue an invalidate command on the processor module bus 160, wherein the command may have otherwise held off an operation that requires the cache line in the external cache module 110.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

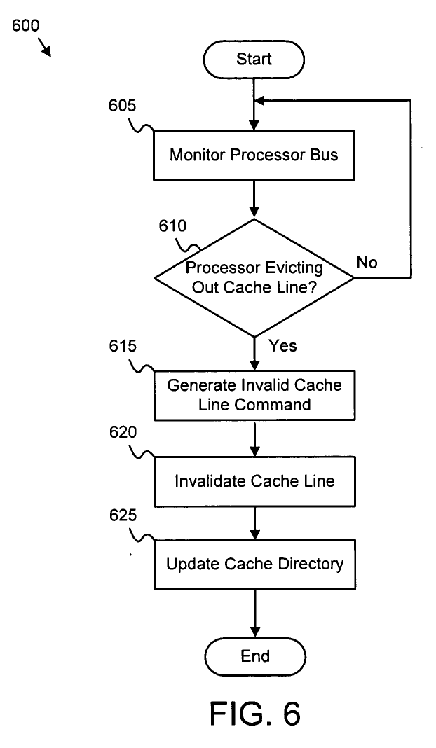

FIG. 6 is a schematic flow chart diagram illustrating one embodiment of an uncertain cache line invalidation method 600 of the present invention. The method 600 substantially includes the steps necessary to carry out the functions presented above with respect to the operation of the described apparatus 200 and systems 100, 300, 400, and 500 of FIGS. 1 through 5.

In one embodiment, the method begins and a monitor module 205 monitors 605 a processor module bus 160. A north bridge module 120 may comprise the monitor module 205. The monitor module 205 may monitor 605 the processor module bus 160 for all transactions involving a memory module 115 or an external cache module 110 such as a processor module 105 evicting a cache line to the external cache module 110. In a certain embodiment, the monitor module 205 monitors 605 each read and write asserted on the processor module bus 160.

A detection module 210 detects 610 the processor module 105 evicting a cache line from a cache module. The detection module 210 is external to the processor module 105. For example, the north bridge module 120 may comprise the detection module 210.

In one embodiment, the cache module is internal to the processor module 105 such as the level 1 cache module 305 of FIG. 3, or the level 1 cache module 305, the level 2 cache module 405, and level 3 cache module 410 of FIG. 4. Because the processor module 105 evicted the cache line, the cache line may be in an uncertain state. For example, a cache directory 315 comprised by the north bridge module 120 such as the north bridge modules 120 of FIGS. 3 through 5 may record that the cache module includes a current instance of the cache line although the processor module 105 has evicted the cache line, because the processor module 105 may evict the cache line without invalidating the cache line in the cache module.

If the detection module 210 does not detect 610 the processor module 105 evicting the cache line, the monitor module 205 may continue to monitor 605 the processor bus module 160. If the detection module 210 detects 610 the processor module 105 evicting the cache line, an invalidation module 215 generates 615 an invalidation command directed to the processor module 105. The invalidation command may be a write command. In a certain embodiment, the invalidation command is a bus line invalidate command.

The invalidation module 215 communicates the invalidation command to the cache module, invalidating 620 the cache line. In one embodiment, the processor module 105 receives the invalidation command and invalidates 620 the cache line in the cache module. In a certain embodiment, the cache module does not record the cache line as being current subsequent to invalidating 620 the cache line.

In one embodiment, an update module 220 updates 625 the cache directory 315. The north bridge module 120 may also comprise the update module 220. The update module 220 may update 625 the cache directory 315 by recording that the cache line is invalid in the processor module 105. The method 600 invalidates 620 the cache line in instances when the processor module 105 is designed not to invalidate the cache line. Thus the method 600 may improve the performance of the processor module 105, particularly when operations frequently access the memory module 115 independent of the processor module 105 such as during a DMA operation.

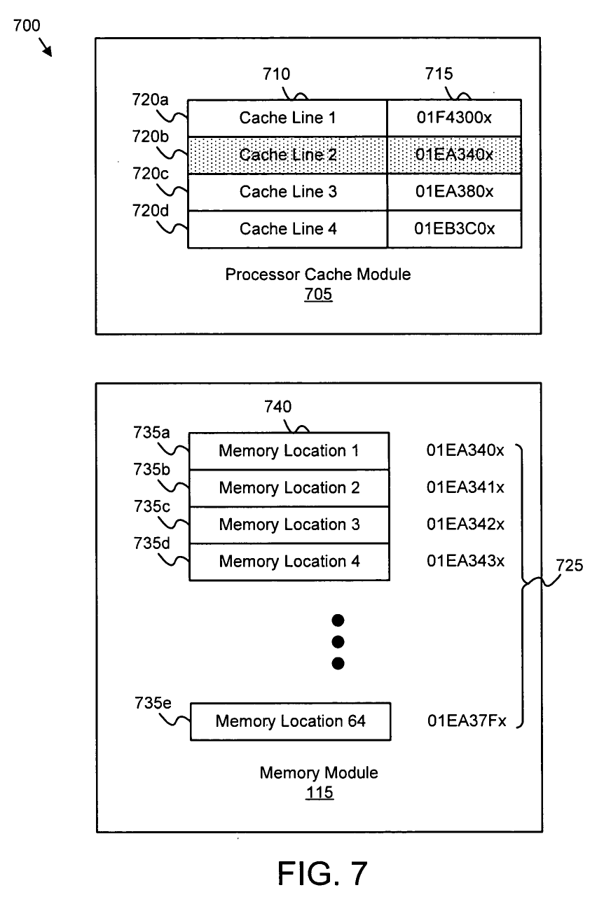

FIG. 7 is a schematic block diagram illustrating one embodiment of cache line eviction 700 of the present invention. A processor cache module 705 such as the level 1 cache module 305 of FIG. 3, the level 1 cache module 305, the level 2 cache module 405, or the level 3 cache module 410 of FIG. 4 includes a plurality of cache lines 720. A memory module 115 comprises a plurality of memory locations 735 each addressed by a unique hexadecimal address 725. In one embodiment, each cache line 720 comprises a plurality of data values 710. Each cache line further comprises a memory address 715 pointing to the beginning of the memory locations 735 where the data values 710 would reside in a memory module 115.

The processor cache module 705 intercepts reads and writes directed to the data values 710 in the memory module 115 at the block of memory locations 735 beginning at the memory address 715. For example, cache line 2 720b contains the data values 710 that would reside as data values 740 in the memory locations 735 at addresses ‘01EA340x’ through ‘01EA37Fx’.

In one embodiment, a processor module 105 evicts cache line 2 720b from the processor cache module 705. The status of cache line 2 720b may be uncertain to a north bridge module 120. For example, a cache directory 315 of the north bridge module 120 may record that cache line 2 720b is current in the processor cache module 705. Thus the north bridge module 120 will not transact an operation with the data values 740 in the memory locations 735 without first snooping the processor cache module 705 although the processor module 105 has evicted the cache line.

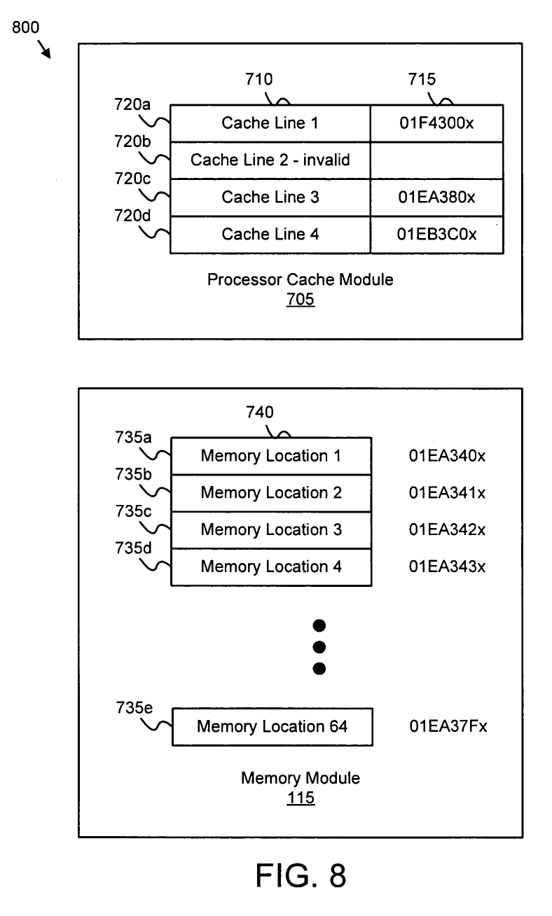

FIG. 8 is a schematic block diagram illustrating one embodiment of uncertain cache line invalidation 800 of the present invention. The cache line invalidation 800 is depicted with the processor cache module 705 and memory module 115 of FIG. 7. A detection module 210 detects 610 the processor module 105 evicting cache line 2 720b from the processor cache module 705. An invalidation module 215 generates an invalid cache line command 615 directed to the processor module 105, invalidating 620 cache line 2 720b. Operations may thus employ the data values 740 of the memory locations 735 in the memory module 115 without first snooping cache line 2 720b in the processor cache module 705 over a processor module bus 160.

The present invention is the first to detect 610 a processor module 105 evicting a cache line 720 from a cache module 705 wherein the state of the cache line 720 may be uncertain. The eviction of the cache line 720 is detected 610 external to the processor module 105. The present invention further invalidates 620 the cache line 720 by externally generating 615 an invalidation command directed to the processor module 105.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to invalidate a cache line, the apparatus comprising:
a detection module external to a processor module and configured to detect the processor module evicting a cache line from a cache module; and
an invalidation module external to the processor module and configured to invalidate the cache line with a cache line invalidation command directed to the processor module.

2. The apparatus of claim 1, further comprising an update module configured to record the cache line as invalid in a cache directory external to the processor module.

3. The apparatus of claim 1, wherein the cache line invalidation command is a write command.

4. The apparatus of claim 1, wherein the cache line invalidation command is a bus line invalidate command.

5. The apparatus of claim 1, wherein the processor module employs an x86-compatible instruction set.

6. The apparatus of claim 1, wherein the processor module comprises the cache module.

7. The apparatus of claim 1, wherein the cache module is configured as a write-back cache.

8. A system to invalidate a cache line, the system comprising:
a processor module configured to execute instructions and process data;
a memory module in communication with the processor module and configured to store the instructions and data in a plurality of memory locations;
a cache module configured to store the contents of one or more memory locations in a plurality of cache lines;
a detection module external to the processor module configured to detect the processor module evicting a cache line from the cache module; and
an invalidation module external to the processor module configured to invalidate the cache line with a cache line invalidation command directed to the processor module.

9. The system of claim 8, further comprising a cache directory external to the processor module and an update module configured to record the cache line as invalid in the cache directory.

10. The system of claim 8, further comprising a plurality of processor modules.

11. The system of claim 10, wherein the plurality of processor modules are configured as a symmetric multiprocessing system.

12. The system of claim 8, wherein the cache line invalidation command is a write command.

13. The system of claim 8, wherein the cache line invalidation command is a bus line invalidate command.

14. A signal bearing medium tangibly embodying a program of machine-readable instructions executable by a digital processing apparatus to perform operations to invalidate a cache line, the operations comprising:
detecting a processor module evicting a cache line from a cache module with a detection module external to the processor module; and
invalidating the cache line with a cache line invalidation command directed to the processor module from an invalidation module external to the processor module.

15. The signal bearing medium of claim 14, wherein the instructions further comprise operations to monitor a processor module bus.

16. The signal bearing medium of claim 14, wherein the instructions further comprise operations to record the cache line as invalid in a cache directory external to the processor module.

17. The signal bearing medium of claim 14, wherein the cache line invalidation command is a write command.

18. The signal bearing medium of claim 14, wherein the cache line invalidation command is a bus line invalidate command.

19. The signal bearing medium of claim 14, wherein the processor module employs an x86-compatible instruction set.

20. The signal bearing medium of claim 14, wherein the processor module comprises the cache module.

21. The signal bearing medium of claim 14, wherein the cache module is configured as a write-back cache.

22. A method for deploying computer infrastructure, comprising integrating computer-readable code into a computing system, wherein the code in combination with the computing system is capable of performing the following:
monitoring a processor module bus;
detecting a processor module evicting a cache line from a cache module with a detection module external to the processor module; and
invalidating the cache line with a cache line invalidation command directed to the processor module from an invalidation module external to the processor module.

23. The method of 22, wherein the cache line invalidation command is a write command.

24. The method claim 22, wherein the cache line invalidation command is a bus line invalidate command.

25. An apparatus to invalidate a cache line, the apparatus comprising:
means for monitoring a processor module bus;
means for detecting a processor module evicting a cache line from a cache module with a detection module external to the processor module;
means for invalidating the cache line with a cache line invalidation command directed to the processor module from an invalidation module external to the processor module; and
means for updating a cache directory external to the processor module.
